(19) United States
(12) Patent Application Publication
(10) Pub. No.: US 2021/0158397 A1
(43) Pub. Date: May 27, 2021

(54) DYNAMIC REAL-TIME BUDGET WALLET TOOL

(71) Applicant: Wells Fargo Bank, N.A., San Francisco, CA (US)

(72) Inventors: Brian Hanafee, Pleasanton, CA (US); Laura Lee Orcutt, Chanhassen, MN (US); Aashir Shroff, Palo Alto, CA (US)

(21) Appl. No.: 15/384,970

(22) Filed: Dec. 20, 2016

Related U.S. Application Data
(60) Provisional application No. 62/272,047, filed on Dec. 28, 2015.
(60) Provisional application No. 62/272,497, filed on Dec. 29, 2015.

(51) Int. Cl. G06Q 30/02; G06Q 40/00; G06Q 20/36

(52) U.S. Cl. CPC G06Q 30/0269; G06Q 20/363; G06Q 30/0201; G06Q 40/12

(57) ABSTRACT

A financial institution computing system is described. The financial institution computing system sets up a budget for a user within a budget tool, and obtains individual budgets for categories of products and services for the user through the budget tool. Each individual budget includes an amount to spend for a corresponding category within a period of time. The financial institution computing system also tracks actual expenditures by the user, and facilitates targeted advertising based on the individual budgets and the actual expenditures.

### CROSS-REFERENCE TO RELATED PATENT APPLICATIONS

This application claims priority to U.S. Provisional Patent Application No. 62/272,047, entitled “DYNAMIC REAL-TIME BUDGET WALLET TOOL”, filed on Dec. 28, 2015, and claims priority to U.S. Provisional Patent Application No. 62/272,497, entitled “DYNAMIC REAL-TIME BUDGET WALLET TOOL”, filed on Dec. 29, 2015, both of which are herein incorporated by reference in their entireties and for all purposes.

### TECHNICAL FIELD

The present disclosure relates generally to the field of digital wallets.

### BACKGROUND

There is a growth in use of digital wallets for shopping goods and services by consumers. A digital wallet refers to a software application that servers as an electronic version of a physical wallet. Consumers desire to enhance their shopping experience with digital wallets that are tailored to their needs. On the other hand, merchants want to use digital wallets as a channel to effectively market and sell their products to improve the return on investment on their marketing efforts. Accordingly, enhanced systems and methods of using digital wallets to facilitate targeted advertising would be desirable.

### SUMMARY

One example embodiment relates to a method of facilitating targeted advertising. The method includes setting up, by a financial institution computing system, a budget for a user within a budget tool, and obtaining, by the financial institution computing system, individual budgets for categories of products and services for the user through the budget tool. Each individual budget includes an amount to spend for a corresponding category within a period of time. The method also includes tracking, by the financial institution computing system, actual expenditures by the user, and facilitating, by the financial institution computing system, targeted advertising based on the individual budgets and the actual expenditures.

Another example embodiment relates to a computing system associated with a financial institution. The computing system includes a budgets database having information relating to budgets of users of the financial institution, a network interface configured to communicate data to and from a payment network computing system, a user device associated with a user, and an advertiser computing system over a network, memory, and a processor. The processor is structured to set up a budget for a user within a budget tool and obtain individual budgets for categories of products and services for the user through the budget tool. Each individual budget includes an amount to spend for a corresponding category within a period of time. The processor is also structured to track actual expenditures by the user, and facilitate targeted advertising based on the individual budgets and the actual expenditures.

A further example embodiment relates to a non-transitory computer-readable media having computer-executable instructions embodied therein, when executed by a processor of a financial institution computing system, cause the financial institution computing system to perform a process. The process includes setting up a budget for a user within a budget tool, and obtaining individual budgets for categories of products and services for the user through the budget tool. Each individual budget includes an amount to spend for a corresponding category within a period of time. The process also includes tracking actual expenditures by the user, and facilitating targeted advertising based on the individual budgets and the actual expenditures.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1A is a block diagram of a computing environment for facilitating targeted advertising by using digital wallets according to an example embodiment.

FIG. 1B is a block diagram of a computing environment for facilitating targeted advertising by using digital wallets according to another example embodiment.

FIG. 2 is a schematic diagram illustrating the remaining budget according to an example embodiment.

FIG. 3 is a schematic diagram illustrating the moving average according to an example embodiment.

FIG. 4 is a flow diagram of a method of facilitating targeted advertising by using digital wallets according to an example embodiment.

FIG. 5 is a flow diagram of a method of facilitating targeted advertising by using digital wallets according to another example embodiment.

FIG. 6 is a flow diagram of a method of facilitating targeted advertising by using digital wallets according to a further example embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting.

Referring generally to the figures, systems and methods for utilizing a budget wallet tool to facilitate targeted advertising are described. More particularly, the present disclosure relates to delivering targeted advertisements to users of digital wallets based on the real-time budget information. A financial institution (e.g., a bank, a credit card network, a payment service, etc.) can set up a digital wallet for a user per the user's request. A budget tool can be programed into the wallet for setting budgets by products/services categories. The user's expenditure can be tracked through the wallet and the user's budget information can be updated real-time. The budget information can be analyzed, and targeted advertisements can be delivered to the user based on the analysis. For example, the delivered advertisements either encourage spending in a category or provides friction towards spending in the category based on the real-time budget information.

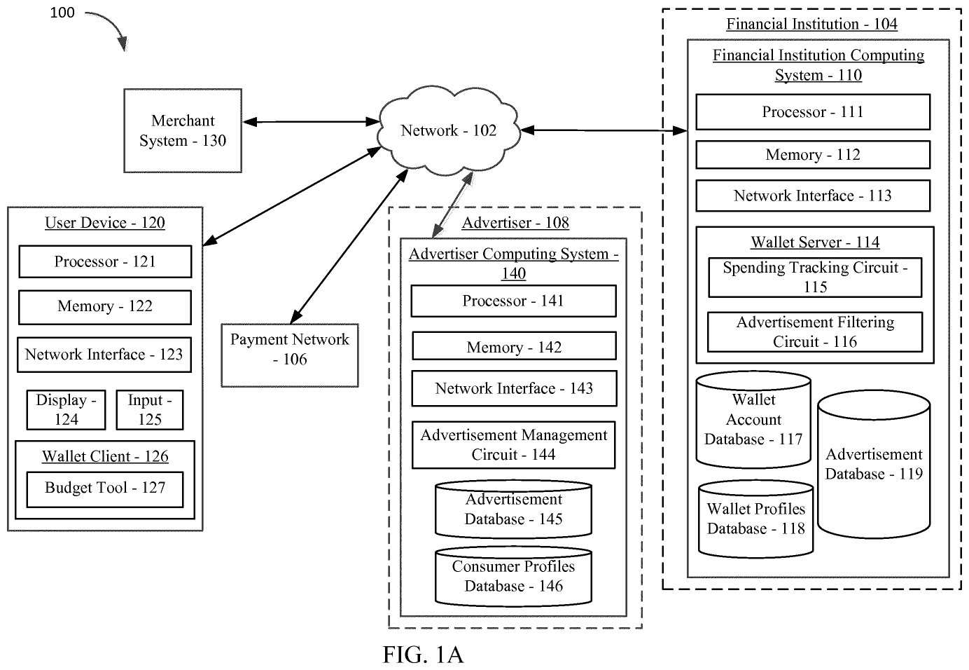

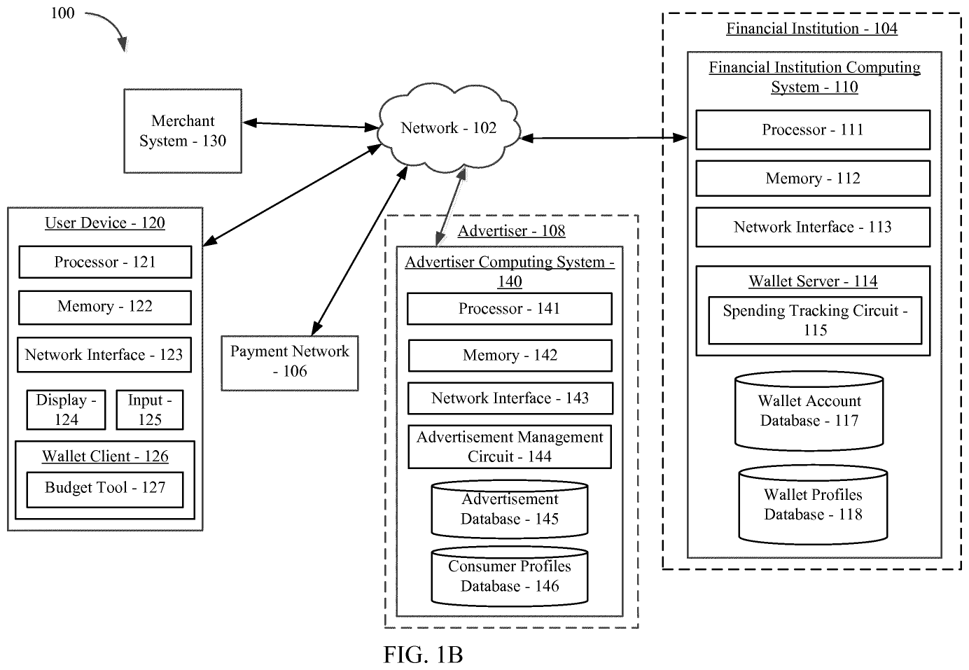

Referring to FIG. 1A, a diagram of a computing environment 100 is shown according to an example embodiment. The computing environment 100 facilitates targeted advertising of an advertiser 108 to a user (e.g., via a user device 120) by using budget information from a digital wallet system hosted by a financial institution 104. The financial institution 104 includes a financial institution computing system 110. In some arrangements, the financial institution computing system 110 is a digital wallet server that facilitates operation of the digital wallet provided by the financial institution 102. The financial institution computing system 110 includes a processor 111, memory 112, and a network interface 113. Memory 112 stores various program instructions that, when executed by the processor 111, control the operation of the financial institution computing system 110. The network interface 113 allows the financial institution computing system 110 to send and receive data to and from external devices and entities via a network 102. The financial institution 104 provides a digital wallet system, which may include a wallet server 114 on the financial institution computing system 110 and a wallet client on a user device 120. The wallet server 114 includes program circuit executable by the processor 111 to implement at least some or all of the functions described herein.

The financial institution computing system 110 includes various databases, for example, a wallet account database 117 and a wallet profiles database 118. The wallet account database 117 stores information relating to wallet accounts. The account information includes user authentication information (e.g., username/password combinations, device authentication tokens, security question answers, etc.) and wallet payment information (e.g., stored credit card information, payment token, etc.). The wallet profiles database 124 stores information relating to profiles of users of the wallet, such as demographic information, budget information, transaction history, and the like. Data pertaining to each individual user of the digital wallet can be collected and stored separately. A profile for each user of the digital wallet system may be generated and maintained by the financial institution computing system 110. The user profile may be continuously updated as users use the wallet for shopping related activities. Data pertaining to each user may continuously be updated forming a feedback loop to enrich and enhance user data residing in the database. In some arrangements, the financial institution 104 allows sharing of information in the wallet profiles database 118, but does not allow sharing of information in the wallet account database 117. For example, the financial institution 104 shares transaction history of users to an advertiser but not the payment information to the advertiser.

The user device 120 may be a smartphone, a portable media device, a personal digital assistant (PDA), a laptop computer, or a personal computer. The user device 120 is associated with a user of the digital wallet system. The user device 120 includes a processor 121, a memory 122, and a network interface 123. Memory 122 stores various program instructions that, when executed by the processor 121, control the operation of the user device 120. The network interface 123 allows the user device 120 to send and receive data to and from external devices and entities via the network 102. The network interface 123 may be a wireless network interface that communicates with a wireless communication protocol (e.g., 802.11a/b/g/n, Bluetooth®, ZigBee®, CDMA, GSM, LTE, WiMax, etc.) or a wired communication protocol (e.g., Ethernet, USB, Thunderbolt®, etc.). The user device 120 includes a display 124 and an input 125. In some arrangements, the display 124 and input 125 are integrated in a touchscreen display. The wallet client 126 includes program logic executable by the processor 121 to implement at least some or all of the functions described herein. The wallet client 126 may be a web browser that is configured to receive and display web pages (e.g., web pages prompting the user to provide information to create an account, web pages displaying account balance information, etc.) or an application executed by the user device 120. The wallet client 126 is configured to communicate with the wallet server 114 on the financial institution computing system 110 via the network 102.

In some arrangements, the user requests to register a digital wallet account with the financial institution 104. The financial institution computing system 110 receives the request from the user device 120. The request may be received during a secure banking session between the user device 120 and the financial institution computing system 110. The request may include user identification information (e.g., a username) and the user's profile input by the user via the input 125. In some arrangements, the financial institution computing system 110 retrieves the user's profile based on the user identification information. The request to register may also include device information relating to the user device 120. In some arrangements where the user device 120 is a mobile device, the device information may relate to a mobile device identifier (e.g., a serial number, an FCC identifier, an international mobile station equipment identity, etc.). The device identifier is used by the financial institution computing system 104 to pair the user device 120 to the user. The account information is stored in the wallet database 117. The user profile information is stored in the wallet profiles wallet database 118.

The financial institution computing system 110 creates a wallet account for the user based on the information received with the request. Creating the account may include generating a unique user account number. Additionally, creating the account may include assigning (or allowing the user to select) a wallet access code (“WAC”). The WAC is entered by the user when logging into the wallet client 126. As an added security measure, the user may be prompted to enter the WAC prior to allowing the user to view the wallet client 126 or pay through the wallet client 126. Additionally, a user token and device token may be generated that are specific to the user and device. The device token is used to register the user device 120 and to link the user device 120 with the user.

When the wallet account is created, the user can provide eligible card information associated with the account. For example, the user may load any credit cards or debit cards that the user owns into the user's wallet account by providing the card information (credit card number, expiration, card code verification number, billing address, etc.) to the financial institution computing system 110 via the wallet client 126. In some arrangements, the user may provide the card information by taking pictures of the cards that the user wants to associate with the wallet account (e.g., a photo of the front of the card and a photo of the back of the card) and upload the photos to the financial institution computing system 110. Additionally, the financial institution computing system 110 may automatically populate the user's wallet account with card information from accounts held with the financial institution 104. For example, the financial institution computing system 110 may automatically populate the user's digital wallet with a credit card issued by the financial institution 102 in the user's name. For automatically pulled card information, the user may be presented with the option to not import identified card information into the user's wallet. The eligible card information is stored in the wallet account database 117. The user can interact with a user interface provided by the wallet client 126 to add, modify, or remove card information from the wallet account.

The wallet client 126 includes a budget tool 127 that allows a budget to be programmed into the digital wallet. The budget tool 127 includes program logic executable by the processor 121 to implement the budgeting functions described herein. In some arrangements, the budget tool 127 allows the user to set a budget for expenditures associated with one or more products or product categories (e.g., “Movie,” “Vacation,” “Apparel,” “Eating out,” etc.). For example, the budget tool 127 includes a user interface for the user to define or select categories for various transaction types and/or merchants such that the user may create a plan that includes budget organized by categories. The budget tool 127 allows the user to set up budget spending amounts for each category within a period of time. For example, the user can set a budget of $300 to spend on eating out every month, a budget of $100 to spend on movies every month, a budget of $5000 to spend on vacations every year, etc. The user-configured budgets may be any of daily, weekly, monthly, or yearly budgets.

In some arrangements, the budget tool 127 automatically creates a budget for expenditures associated with products or product categories for the user based on the user's past behavior, current behavior, predicted future behavior, statistics, etc. For example, the budget tool 127 may retrieve information relating the user from the wallet profiles database 118, including the user's transaction history, location-based profiling, income-based profiling, debt burden, tax burden, family status, etc. The budget tool 127 may also retrieve other information from various databases of the financial institution computing system 110, including, housing costs in the location, utility costs in the location, rental costs in the location, food costs in the location, and so on. Based on the information retrieved, the budget tool 127 populates each category with a budget spending amount. The budget tool 127 can transmit the budget information to the wallet profiles database 118 for the use by the financial institution 104.

In some arrangements, the user can change the budget spending amounts through the budget tool 127. In further arrangements, the budget tool 127 provides the user with a budget analysis that may include status reports, alert, and/or other messages regarding one or more categories of budget. The budget tool 127 may include a graphical comparison of actual spending amounts versus budget spending amounts for a variety of transaction categories over a period of time such as one month, one year, etc. Alternatively, the budget tool 127 provides data in a textual format, including actual spending amounts, budget spending amounts, and over/under values indicating the amounts by which the actual spending amounts are over and/or under the budgeted amounts.

Actual spending by the user is tracked by a spending tracking circuit 115 on the wallet server 114 and is used to update the budget information stored in the wallet profiles database 118. The user purchases products/services provided by a merchant via a merchant system 130. The merchant system 130 may include a merchant point of sale (“POS”) system located at various physical store locations. The merchant system 130 may also include a web server that hosts an internet retailer website providing online shopping. The user can purchase products/services at a physical store or online. The user can make payments by using the wallet client 126, using the physical cards, or providing information on the cards (e.g., number of the card, expiration date, etc.). The spending tracking methods regarding different payment forms are discussed in detail below.

The user can use the wallet client 126 to make payments to merchants both online and on-site. As discussed above, the digital wallet account associates one or more payment forms that can be used for online purchases and on-site purchases with the user. Each payment form can include or be associated with a financial account, such as a credit card account, a debit card account, a checking account, a savings account, a loyalty rewards account, or other type of account that can be used to make a purchase. The financial institution computing system 110 stores, for each payment form, payment information including any of, for example, a financial account identifier (for example, account number, card number), an account routing number, an expiration date of one or more financial cards associated with the financial account, and/or a billing address for the account, etc. The payment information can also include information associated with the user, such as name, contact information, demographic information, or any other suitable information associated with the user. The payment information can also include shipping information, such as one or more shipping addresses. In some arrangements, the wallet client 126 is a mobile wallet client hosted or executed by a mobile device. In other arrangements, the wallet client 126 is hosted remote from the mobile device and is accessed by the mobile device. In such arrangements, the wallet client 126 may be, for example, a website accessed by the user via the mobile device.

In some arrangements, the user manually opens the wallet client 126 at the time of purchasing goods/services offered by the merchant. In other arrangements where the wallet client 126 is a mobile wallet client on a mobile device, it can automatically open when the mobile device approaches a merchant POS terminal (e.g., based on detected NFC signals emitted by the merchant POS terminal). In both cases, the user can enter their WAC to access (i.e., unlock) the wallet client 126. After the wallet client 126 is unlocked, the user can select a payment form from the payment forms associated with the wallet account of the user. In some arrangements, no selection is needed if the user has configured a default payment method.

In some arrangements where the wallet client 126 is a mobile wallet client on a mobile device, the computing environment 100 facilitates electronic and card-less payments of the mobile wallet client to a merchant POS terminal through host card emulation (“HCE”). For example, when the payment form is selected, the mobile wallet client communicates with the financial institution computing system 110 and downloads a payment token or a barcode that emulates a card from the financial institution computing system 110. If selected payment form is the default payment form, the payment token or the barcode can be stored locally with the memory of the mobile device. The user attempting to make a purchase at the merchant passes the payment token to the POS terminal. In some arrangements, the mobile wallet client wirelessly communicates with the merchant POS terminal, such as through a NFC transmitter of the mobile device. In other arrangements, the mobile wallet client presents barcodes (e.g., two-dimensional barcodes or there-dimensional barcodes) on the display 124 that are scanned by a scanner of the merchant POS terminal. In some arrangements, the barcodes can be wireless transmitted to the merchant POS system from the user's mobile device (e.g., via Bluetooth®, near field communication, radio frequency identification, 802.11 wireless networking, Zigbee®, etc.).

The merchant POS terminal then transmits the received token/barcode to a payment network 106 for approval to proceed with the transaction in a similar manner that the merchant POS terminal would transmit a normal card transaction authorization request. In some arrangements, the payment network 106 includes a financial institution that guarantees credit and debit card transactions (e.g., a credit card association, a credit card issuer, etc.). The financial institution of the payment network 106 may be the same as or different than the financial institution 104 that issues the digital wallet. In some arrangements, the payment network 106 is embodied as a computing system or server. The payment network 106 may confer with the financial institution computing system 110 prior to approving the payment. The approval may include verifying that the account associated with the payment token is active and has enough remaining credit to proceed with the transaction. A payment confirmation is received from either the financial institution or the payment network. The payment confirmation relates to a confirmation that the payment source was accepted and that the transaction is approved or a payment denial message. The payment confirmation is received by the mobile device and/or by the merchant POS terminal. This process is described in further detail in U.S. patent application Ser. No. 14/501,856, entitled “MOBILE WALLET ACCOUNT ACTIVATION SYSTEMS AND METHODS,” filed on Sep. 30, 2014, and in U.S. patent application Ser. No. 14/501,880, entitled “MOBILE WALLET ACCOUNT PROVISIONING SYSTEMS AND METHODS,” filed on Sep. 30, 2014, both of which are hereby incorporated by reference in their entireties and for all purposes.

When the payment is confirmed, the spending tracking circuit 115 on the wallet server 114 analyzes the transaction to identify a category that the expenditure falls into based on, for example, the merchant information and/or the products/services information. For example, if the merchant involved in a transaction is a movie theatre or if the product is a DVD, the spending tracking circuit 115 puts the expenditure into the “Movie” category. If the merchant is a travel agency or if the service is a vacation package, the spending tracking circuit 115 puts the expenditure into the “Vacation” category, and so on. The spending tracking circuit 115 can record the transaction in the wallet profiles database 118 and update the budget information for the corresponding category, e.g., subtracting the dollar amount spent in the transaction from the remaining budget for that category. The user profile may be continuously updated as the user uses the wallet for shopping related activities. The continuously updated data pertaining to the user profile may form a feedback loop to enrich and enhance the wallet profiles database 118.

In addition to or instead of the mobile wallet client, users may also be provided with the ability to access the wallet account using another type of computer (e.g., a desktop or laptop computer executing browser software or an application) to perform transactions with merchants.

The user can also use the physical card or provide information on the cards to purchase products or services offered by merchants. In some arrangements, every time the user make a payment involving the payment network 106, the payment network 106 provides the transaction information to the financial institution computing system 110. In other arrangements, the payment network 106 periodically updates the financial institution computing system 110 with the transactions made (e.g., every ten minutes, every hour, every day, every time the user logs into the wallet client, etc.). After the user's spending information is provided to the financial institution computing system by the payment network 106, the spending tracking circuit 115 on the wallet server 114 identifies a category the expenditure falls into and updates the budget information regarding that category accordingly. In further arrangements, the user can manually update expenditure information, for example, information on cash transactions, and/or spending information not otherwise provided by the payment network 106.

The computing environment 100 facilitates targeted advertising of an advertiser 108 by using the budget information. The advertiser 108 may include an individual, a company, or other entity that is interested in online advertising opportunities. For example, the advertiser 108 can be a store having a physical presence, an on-line store and the like, which sell or deliver goods and provide services directly to users ordering via the Internet or mobile terminals. In some arrangements, the advertiser 108 is an advertising agency that designs and/or implements an advertising campaign on behalf of one or more clients. The advertiser 108 can thus refer to a brand owner, a service provider, an advertisement agent, a merchant or any other party that wants to provide advertisement to consumers. Advertisements placed via the digital wallet system can be commercial, such as a product or service promotion, or non-commercial, such as a general information service notification. The advertisements delivered to consumers may include one or more items available for purchase and each advertiser may provide a plurality of advertisements for multiples ones of its products. The advertisements include any of data, text, pictures, video, audio, links, television content, videos, HTML, XML, xHTML, WAP pages, web pages, etc., or any digital content compatible for reception and display by the user device 120. In some arrangements, the advertisements can include links to external content. The presence of one or more links in advertisements enables consumers receiving the advertisements to activate the link and be directed to the external content (e.g., a website associated with the advertiser where the user can purchase the advertised items).

The advertiser 108 operates an advertiser computing system 140. The advertiser computing system 140 includes a processor 141, memory 142, and a network interface 143. Memory 142 stores various program instructions that, when executed by the processor 141, control the operation of the advertiser computing system 140. The network interface 143 allows the advertiser computing system 140 to send and receive data to and from external devices and entities via the network 102. The network interface 143 may be a wireless network interface that communicates with a wireless communication protocol (e.g., 802.11a/b/g/n, Bluetooth®, ZigBee®, CDMA, GSM, LTE, WiMax, etc.) or a wired communication protocol (e.g., Ethernet, USB, Thunderbolt®, etc.).

The advertiser 108 generally seeks to maximize the effect or impact of its advertisements and to have an acceptable return on investment from advertising efforts through targeted advertising. As used herein, targeted advertising refers to placing advertisements so as to reach specific consumers (or consumer groups) based on various traits such as demographics, psychographics, behavioral variables (e.g., product purchase history), budget (e.g., remaining budget) etc. For example, goods and services are marketed to particular target groups of users sharing a common profile which may be selected to increase the likelihood of the users responding to the advertisements and purchasing the advertised goods and services. Another example is that, goods and services are marketed to users that have enough budget so as to increase the likelihood of purchase. The advertiser computing system 140 includes an advertisement management circuit 144 configured to decide whether to serve an advertisement to a consumer, which advertisement to serve, and when to serve the advertisement to the consumer based on rules of an advertising campaign and the consumer's traits. For example, the rules defined by the advertising campaign include, but not limited to, the time period or periods when to send advertisements, the duration of the advertising campaign, the target group or groups, demographics of the target group(s), the format or type of advertisements, the target price level or cost per advertisement or for the advertising campaign in its entirety, the sociological background of the target audience, demographics of the target group(s) including, e.g., age, sex, and income level(s), target telephone type, etc.

The advertiser computing system 140 may include various databases, e.g., an advertisement database 145 and a consumer profiles database 146. The advertisement database 145 may store information relating to advertisements, e.g., advertisement pages of merchants, uniform resource locators (URLs) of advertisements, statistics of advertisements (e.g., click-through rates), etc. The consumer profiles database 146 may store information regarding consumers, including the consumer's demographic information, browsing and transaction history, location, preferences, user device information, etc.

In the arrangements shown in FIG. 1A, the advertiser computing system 140 delivers the advertisements determined by the advertisement management circuit 144 for a consumer group with a common profile to the financial institution computing system 110 for passing along to individual users. The financial institution computing system 110 includes an advertisement database 119 that stores the incoming advertisements and the profile of the targeted group. The advertisement database may also store advertisement based performance metrics, such as the number of times an advertisement is viewed, clicked, and acted upon as per the call-to-action in the advertisement by consumers. The financial institution computing system 110 also includes an advertising filtering circuit 116 configured to use consumer specific data, e.g., budget information, to decide whether to serve the incoming advertisements and which advertisements to serve to the consumer.

The network 102 facilitates communication between the above-noted devices and entities. The network 112 may include private networks, public networks, or a combination thereof. In some arrangements, the network 102 includes the Internet.

In some arrangements, the advertisement filtering circuit 116 retrieves the real-time budget information from, for example, the wallet profiles database 118 in order to accomplish its advertisements filtering functions. Based on the real-time budget information obtained, the advertisement filtering circuit 116 can either encourage spending in a particular category or provides friction towards spending in the category. For example, to encourage spending, the advertisement filtering circuit 116 delivers targeted advertisements about how to use the remaining budget for the particular category. To provide friction, the advertisement filtering circuit delivers advertisements on alternatives in the category that incur lower cost, recommends the consumer to shift budgets, or stops credit cards, etc.

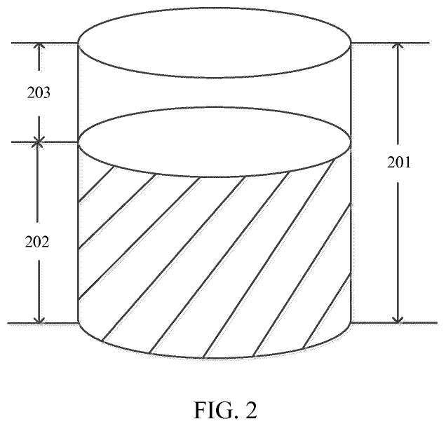

The decision made by the advertisement filtering circuit 116 is a dynamic real-time decision. In some arrangements, the advertisement filtering circuit 116 compares the remaining budget of each category for a period of time to the purchase price of the goods and/or services the advertiser wants to advertise in the category. A diagram illustrating the remaining budget is shown in FIG. 2 according to an example user situation. For example, the user sets a budget of $100 for the “Movie” category every month, which is represented by volume 201. The spending tracking circuit 115 tracks the actual expenditure by the user and categorizes the expenditure. For example, if the merchant involved in a transaction is a movie theatre, a DVD rental store, or a streaming service provider, or if the product purchased is a DVD, the spending tracking circuit 115 puts the expenditure into the “Movie” category. The spending tracking circuit 115 updates the budget information for the “Movie” category, e.g., subtracting the dollar amount spent in the transaction from the remaining budget for the “Movie” category. At some point of the month, the user has spent $70 on movies (represented by volume 202), according to the spending tracking circuit 115. The remaining budget for the “Movie” category would be $30, which is represented by volume 203. The advertisement filtering circuit 116 compares the $30 remaining budget for the “Movie” category to an advertisement in this category and decides whether to deliver the advertisement based on the comparison. For example, the advertisement filtering circuit 144 will deliver an advertisement on a $20 DVD but will not deliver an advertisement on a $50 monthly movie pass to the consumer.

In some arrangements, the advertisement filtering circuit 116 decides to provide incentive or friction based on a “pro rata” spending, i.e., whether the actual expenditure is behind or ahead of the budgeted expenditure. For example, if the user spent the $70 early on in the month, e.g., the first week, the advertisement filtering circuit 116 decides that the actual expenditure is “ahead of” the budgeted expenditure for the “Movie” category, and creates some friction towards spending in the “Movie” category. For example, the advertisement filtering circuit 116 stops delivering advertisements on movies but delivers advertisements on products/services of another category for which the actual expenditure is behind budgeted expenditure (e.g., outdoor sports) to the user. In some arrangements, the advertisement filtering circuit 116 has the wallet server 114 ask the user to shift budgets from another category for which the actual expenditure is behind budgeted expenditure to the “Movie” category, e.g., prompting a message through a user interface, “Shifting budgets from Outdoor sports to Movie?” In some arrangements, the advertisement filtering circuit 116 delivers advertisements on less expensive alternatives in the “Movie” category. For example, instead of delivering advertisements from a luxurious movie theatre, the advertisement filtering circuit 116 delivers advertisements from DVD rental stores or online rental services. In some arrangements, the advertisement filtering circuit 116 has the wallet server 114 stop credit cards when they are used on the expenditures in the “Movie” category, e.g., prompting a message through a user interface, “Expenditure ahead of budget. Credit card stopped for expenditure on movie.”

If the user spent the $70 when the month is almost over, the advertisement filtering circuit 116 decides that the actual expenditure is “behind” the budgeted expenditure for the “Movie” category and provides incentive encouraging the user to spend the $30 remaining budget. For example, the spending tracking circuit 115 delivers advertisements from a luxurious movie theatre to the user. In some arrangements, the advertisement filtering circuit 116 has the wallet server 114 ask the user to shift budgets from the “Movie” category to another category in which the actual expenditure is ahead of the budgeted expenditure, e.g., prompting a message through a user interface, “Shifting budgets from Movie to Outdoor sports?” When the user decides to order an advertised item, it can be ordered through the wallet client 126. In some arrangements, the advertisement database 119 can keep track of success of the advertising as reflected by sales of the advertised goods and/or services.

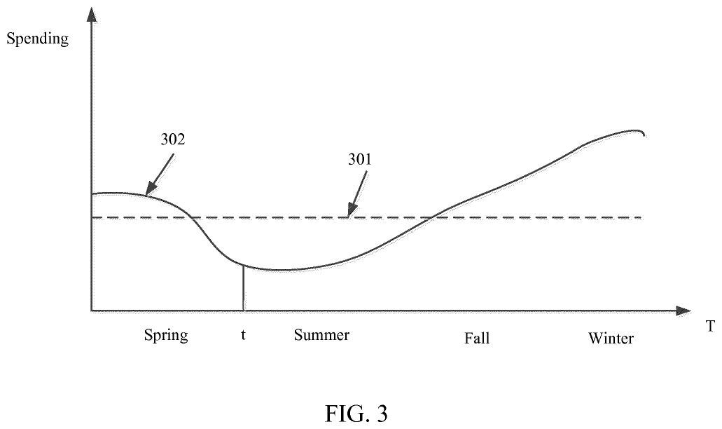

In some arrangements, the advertisement filtering circuit 116 decides to provide incentive or friction based on a moving average of the actual spending in a category. As used herein, the moving average refers to the average spending for a most recent period of time, e.g., the latest week, month, season, etc. The advertisement filtering circuit 116 compares the moving average to the budgeted average. If the moving average is lower than the budgeted average, the advertisement filtering circuit 116 provides incentive to the user; if the moving average is higher than the budgeted average, the advertisement filtering circuit 116 provides friction. A diagram illustrating the moving average is shown in FIG. 3. Instead of setting a monthly budget of $100 for the “Movie” category, the user sets an annual budget of $1200. The budgeted average for each month is $100, which is represented by the dashed line 301. The curve 302 shows the moving average spending that changes over time. For a time point t, the moving average is the spending in a period of time that starts from a month before t to t. As shown in FIG. 3, the moving average 302 is slightly higher than the average 301 in spring, lower than the average 301 in summer, and higher than the average in fall and winter. Thus, in spring, fall, and winter, the advertisement filtering circuit 116 will provide “frictions,” i.e., stop delivering advertisements on movies but deliver advertisements on products/services of another category for which the moving average of actual spending is lower than the budgeted average (e.g., outdoor sports) to the user; ask the user to shift budgets from that category to the “Movie” category, delivers advertisements on less expensive alternatives in the “Movie” category, or stop credit cards when they are used for expenditures on movie, etc. In summer, the advertisement filtering circuit 116 will provide incentive, i.e., deliver advertisements from a luxurious movie theatre to the user; ask the user to shift budgets from the “Movie” category to another category in which the moving average of actual spending is above the budgeted average, etc.

Another example of a computing environment that facilitates targeted advertising by using the budget information is shown in FIG. 1B. Comparing to FIG. 1A, the environment of FIG. 1B integrates the functions performed by the advertisement filtering circuit 116 on the financial institution computing system 110 into the advertisement management circuit 144 of the advertiser computing system 140. In particular, the wallet server 114 of the financial institution computing system 110 tracks the consumer's real-time spending and provides the information to the advertiser computing system 140 via the network 102. The financial institution computing system 110 can periodically update the advertiser computing system 140 with the budget information (e.g., every ten minutes, every hour, every day, etc.) according to agreements between the advertiser 108 and the financial institution 104. The advertisement computing system 140, when making decisions regarding whether to deliver an advertisements, which advertisement to deliver, and when to deliver the advertisement to the consumer, takes into account the information (e.g., budget information) received from the financial institution computing system 110. The way that the advertisement management circuit 144 considers the budget information may be similar to how the advertisement filtering circuit 116 makes decisions, as discussed above. The advertisement management circuit 144 can determine and select which advertisement(s) to delivered to the consumer via the network 102. In some arrangements, the advertiser computing system 140 delivers the determined advertisements to the financial institution computing system 110 that passes the advertisements along to the user device 120. In some arrangements, the advertiser computing system 140 delivers the advertisements to the user device 120 directly. When the user decides to order an advertised item, it can be ordered through the wallet client 126. The advertisement database 19 could keep track of success of its advertising as reflected by sales of the advertised goods and/or services.

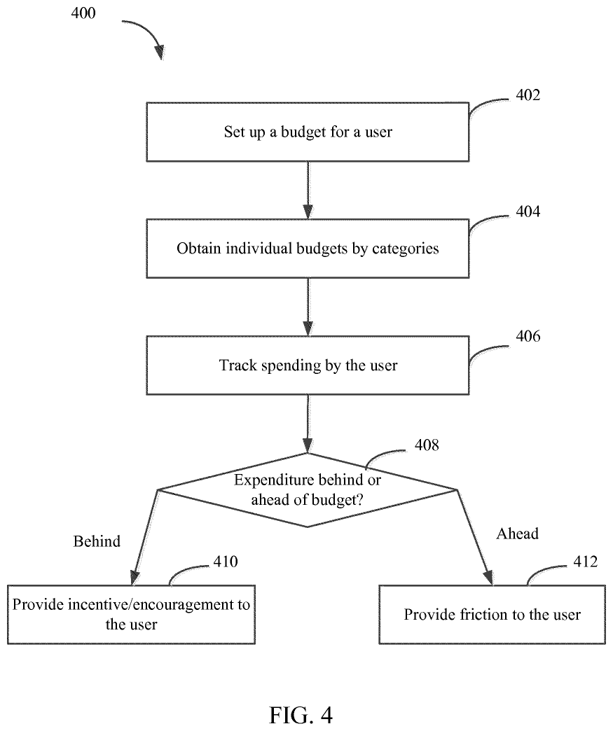

Referring to FIG. 4, a flow diagram of a method 400 of facilitating targeted advertising by using digital wallets is shown according to an example embodiment. The method 400 is performed by the financial institution computing system 110 (e.g., by the processor 111). Alternatively, some operations of the method 400 are performed by the advertising computing system 140 (e.g., by the processor 141).

The method 400 begins when a digital wallet is set up for a user at 402. The financial institution computing system 110 receives a request to register a digital wallet account from the user device 120. The request may include user identification information (e.g., a username) and the user's profile input by the user or retrieved by the financial institution computing system 110 based on the user identification information. The request to register may include device information (e.g., a mobile device identifier) relating to the user device 120. The financial institution computing system 110 creates a wallet account for the user based on the information received with the request. Creating the account includes generating a unique user account number or identification. Additionally, creating the account may include assigning (or allowing the user to select) a wallet access code (“WAC”). In some arrangements, a user token and device token are generated that are specific to the user and device. The device token is used to register the user device 120 and to link the user device 120 with the user. The financial institution computing system 110 generates and maintains a profile of the user. The user profile may be continuously updated as the wallet is used for shopping related activities. When the wallet account is created, the user provides eligible card information (credit card number, expiration, card code verification number, billing address, etc.) associated with the account. In arrangements where the user is also an existing account holder with the financial institution 104, the financial institution computing system 110 can automatically populate the user's wallet account with card information from accounts held with the financial institution 104. The user can add, modify, or remove payment information from the wallet account.

Budgets by categories are obtained for the user at 404. The digital wallet provides a budget tool 127 that allows a budget to be programmed into the digital wallet. The user can set a budget for expenditures associated with one or more products or product categories within a period of time. The budget tool 127 includes a user interface for the user to define or select categories for various transaction types and/or merchants such that a user may create a plan that includes a budget organized by categories. Additionally, the budget tool 127 can automatically create a budget for expenditures associated with products or product categories for the user based on the user's past behavior, current behavior, predicted future behavior, or other information. The budget tool 127 may receive information about the user from the wallet account database 117 and the wallet profiles database 118, and various databases on the financial institution computing system 110. Based on the information received, the budget tool 127 populates each category with the budget spending amounts. The user can change the budget spending amounts via the budget tool 127.

Spending by the user is tracked at 406. The user can purchase products/services offered by merchants at a physical store or online. The user can make payments by using the wallet client 126, using the physical cards, or providing information on the cards. For payments made through the digital wallet, the financial institution computing system 110 records the transactions. For payments made through other means, the financial institution computing system 110 obtains the transaction information from the payment network 106. The financial institution computing system 110 can take the user's manual update of expenditure information, for example, information on cash transactions, and/or spending information not otherwise provided by the payment network 106. The budgets are monitored by tracking the spending. The financial institution computing system 110 identifies a category each transaction falls into based on the merchant information and/or the product/service information and updates the budget information accordingly, e.g., determines the remaining budget for each category by subtracting the amount spent in the transaction.

Whether the expenditure is behind or ahead of the budgeted expenditure is determined for each category at 408. As discussed above, the budget is set for a period of time. The financial institution computing system 110 compares the percentage of time that has passed to the percentage of budget that has been spent. If the percentage of passed time is larger than the percentage of the spent budget, the expenditure is determined behind the budget for that category meaning the user can spend additional money or increase the rate of spending for the budget within the budget time period. If the percentage of passed time is smaller than the percentage of the spent budget, the expenditure is determined ahead of the budget meaning the user should spend less money or decrease the rate of spending for the budget within the budget time period.

If the expenditure is determined behind the budgeted expenditure at 408, incentive or encouragement to spend is provided to the user at 410. The financial institution computing system 110 delivers targeted advertisements about how to use the remaining budget for the corresponding budget category to encourage spending, asks the user to shift budgets from the category to another category in which the actual expenditure is ahead of the budgeted expenditure, etc.

If the expenditure is determined ahead of the budget at 408, friction is provided to the user at 412. The financial institution computing system 110 stops delivering advertisements on products/services in the category but delivers advertisements on products/services of another category for which the actual expenditure is behind the budgeted expenditure to the user; asks the user to shift budgets from another category for which the actual expenditure is behind the budgeted expenditure to that category; delivers advertisements on less expensive alternatives in the category, or stop credit cards when they are used for expenditures on products/services in the category, etc. In some arrangements, operations of the method 408, 410, and 412 are performed by the advertising computing system 140 (e.g., by the processor 141).

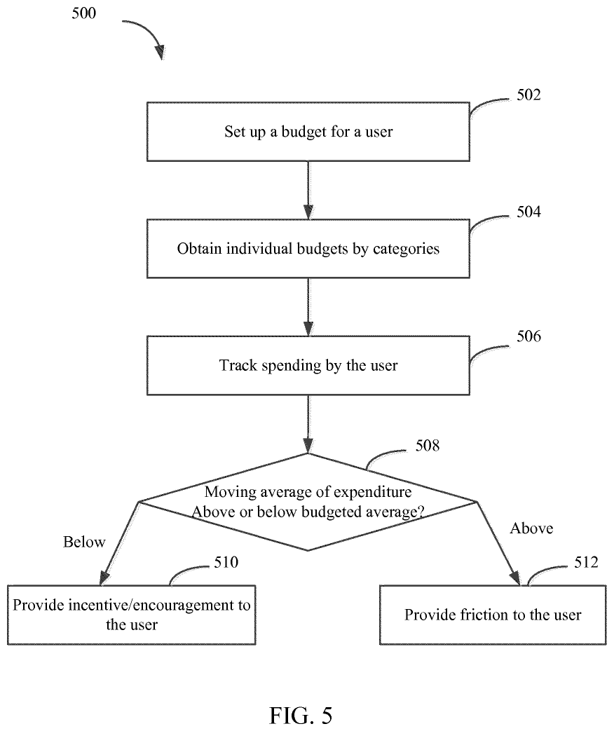

Referring to FIG. 5, a flow diagram of a method 500 of facilitating targeted advertisement based on budget information is shown according to an example embodiment. The method 500 can be performed by the financial institution computing system 110. Alternatively, some operations of the method 500 are performed by the advertising computing system 140 (e.g., by the processor 141).

Operations of the method 500 are similar to those of the method 400 except 508. At 508, whether a moving average of expenditure is above or below the average budget is determined. The moving average refers to the average spending for a most recent period of time. The financial institution computing system 110 compares the moving average spending to the budgeted average. If the moving average is determined lower than the average budget at 508, incentive is provided to the user at 510; if the moving average is determined higher than the average budget at 508, the advertisement filtering circuit provides friction at 512. In some embodiments, operations 508, 510, and 512 are performed by the advertising computing system 140 (e.g., by the processor 141).

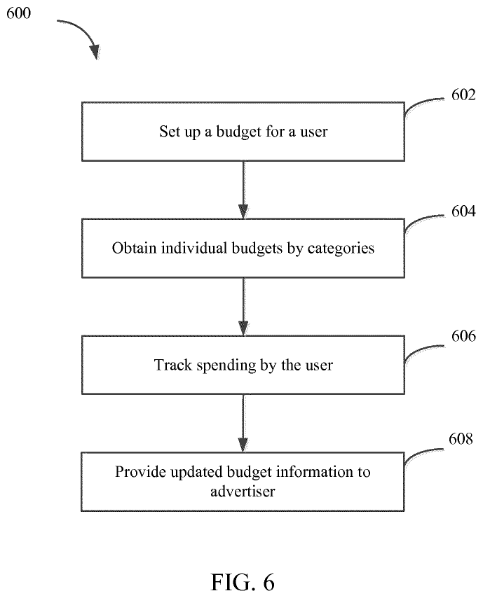

Referring to FIG. 6, a flow diagram of a method 600 of facilitating targeted advertisement based on budget information is shown according to an example embodiment. The method 600 can be performed by the financial institution computing system 110.

Operations of the method 500 are similar to those of the method 400 and the method 500 except 608. Instead of analyzing the spending and budget by itself, the financial institution computing system 110 provides the tracked real-time spending/budget information to an advertiser. The advertiser analyzes the data and provide incentive or frictions based on the analysis.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. (canceled)

2. (canceled)

3. A method of facilitating targeted advertising, the method comprising:
setting up, by a financial institution computing system, a budget for a user within a budget tool, the budget tool located on a mobile wallet client hosted on a user device associated with the user;
obtaining, by the financial institution computing system, individual budgets for categories of products and services for the user through the budget tool, wherein each individual budget includes an amount to spend for a corresponding category within a period of time, and wherein each individual budget is input by the user via a user interface of the budget tool;
tracking, in real-time by the financial institution computing system, actual expenditures by the user, the tracking comprising:
receiving, by the financial institution computing system, a payment confirmation message associated with an expenditure made by the user,
wherein the expenditure is conducted via a mobile wallet client of the user that communicates with a merchant point of sale (POS) system using Near Field Communication (NFC) signals; and
analyzing the payment confirmation message to identify a particular category from among the categories of products and services that the expenditure falls into to determine the actual expenditures for that particular category;
facilitating, in real-time by the financial institution computing system, targeted advertising based on the individual budgets and the actual expenditures,
wherein the facilitating targeted advertising includes:
comparing a price of a particular product or service in the particular category offered by an advertisement with a remaining budget of the particular category, wherein the remaining budget is the balance of the budget for the particular category and the actual expenditures for that particular category; and
delivering the advertisement via the mobile application hosted on the user device in response to a comparison that the price is not higher than the remaining budget;
stopping a credit card associated with the mobile wallet client on the user device in response to a comparison that the price is higher than the remaining budget; and
providing a notification via the user device that the price is higher than the remaining budget.

4. The method of claim 3, wherein the facilitating targeted advertising includes:
not delivering the advertisement in response to a comparison that the price is higher than the remaining budget.

5. A method of facilitating targeted advertising, the method comprising:
setting up, by a financial institution computing system, a budget for a user within a budget tool, the budget tool located on a mobile application hosted on a user device associated with a user;
obtaining, by the financial institution computing system, individual budgets for categories of products and services for the user through the budget tool, wherein each individual budget includes an amount to spend for a corresponding category within a period of time, and wherein each individual budget is input by the user via a user interface of the budget tool;
tracking, in real-time by the financial institution computing system, actual expenditures by the user,
wherein the actual expenditures are conducted via a mobile wallet client hosted on the user device that communicates with a merchant point of sale (POS) system using Near Field Communication (NFC) signals; and
facilitating, in real-time by the financial institution computing system, targeted advertising based on the individual budgets and the actual expenditures,
wherein the facilitating targeted advertising includes:
determining whether the actual expenditure in a particular category is behind or ahead of the budget for the particular category; and
providing an incentive that encourages spending in the particular category to the user in response to determining that the actual expenditure is behind the budget, and
wherein the providing the incentive comprises displaying an advertisement corresponding to the particular category on the mobile application hosted on the user device associated with the user.

6. The method of claim 5, wherein the determining the actual expenditure is behind the budget includes:
comparing a first ratio of time that has passed to the period of time set for the particular category with a second ratio of the actual expenditure to the budget set for the particular category; and
determining that the actual expenditure is behind the budget in response to a comparison that the first ratio is higher than the second ratio.

7. The method of claim 5, wherein the providing an incentive includes at least one of delivering advertisements about how to use a remaining budget for the particular category, and asking the user to shift budget from the particular category to another category for which the actual expenditure is ahead of the budget.

8. A method of facilitating targeted advertising, the method comprising:
setting up, by a financial institution computing system, a budget for a user within a budget tool, the budget tool located on a mobile application hosted on a user device associated with a user;
obtaining, by the financial institution computing system, individual budgets for categories of products and services for the user through the budget tool, wherein each individual budget includes an amount to spend for a corresponding category within a period of time, and wherein each individual budget is input by the user via a user interface of the budget tool;
tracking, in real-time by the financial institution computing system, actual expenditures by the user,
wherein the actual expenditures are conducted via a mobile wallet client hosted on the user device that communicates with a merchant point of sale (POS) system using Near Field Communication (NFC) signals; and
facilitating, in real-time by the financial institution computing system, targeted advertising based on the individual budgets and the actual expenditures,
wherein the facilitating targeted advertising includes:
determining whether the actual expenditure in a particular category is behind or ahead of the budget for the particular category; and
stopping a credit card associated with the mobile application hosted on the user device in response to the determination that the actual expenditure is ahead of the budget; and
providing a notification via the mobile application that the actual expenditure is ahead of the budget.

9. The method of claim 8, wherein the determining the actual expenditure is ahead of the budget includes:
comparing a first ratio of time that has passed to the period of time set for the particular category with a second ratio of the actual expenditure to the budget set for the particular category; and
determining that the actual expenditure is ahead of the budget in response to a comparison that the first ratio is lower than the second ratio.

10. The method of claim 8, wherein the providing a friction includes at least one of stopping delivering advertisements on products and services in the particular category, asking the user to shift budget from another category for which the actual expenditure is behind the budget to the particular category, delivering advertisements on less expensive alternatives in the particular category, and stopping credit cards when they are used for expenditures on products and services in the particular category.

11. A method of facilitating targeted advertising, the method comprising:
setting up, by a financial institution computing system, a budget for a user within a budget tool, the budget tool located on a mobile application hosted on a user device associated with a user;
obtaining, by the financial institution computing system, individual budgets for categories of products and services for the user through the budget tool, wherein each individual budget includes an amount to spend for a corresponding category within a period of time, and wherein each individual budget is input by the user via a user interface of the budget tool;
tracking, in real-time by the financial institution computing system, actual expenditures by the user,
wherein the actual expenditures are conducted via a mobile wallet client hosted on the user device that communicates with a merchant point of sale (POS) system using Near Field Communication (NFC) signals; and
facilitating, in real-time by the financial institution computing system, targeted advertising based on the individual budgets and the actual expenditures,
wherein the facilitating targeted advertising includes:
comparing a moving average of the actual expenditure in a particular category is above or below a budgeted average for the particular category; and
providing an incentive that encourages spending in the particular category to the user in response to a comparison that the moving average is below the budgeted average; and
delivering the target advertising via the mobile application hosted on the user device.

12. The method of claim 11, wherein the facilitating targeted advertising includes:
providing a friction towards spending in the particular category to the user in response to a comparison that the moving average is above the budgeted average.

13. A method of facilitating targeted advertising, the method comprising:
setting up, by a financial institution computing system, a budget for a user within a budget tool, the budget tool located on a mobile application hosted on a user device associated with a user;
obtaining, by the financial institution computing system, individual budgets for categories of products and services for the user through the budget tool, wherein each individual budget includes an amount to spend for a corresponding category within a period of time, and wherein each individual budget is input by the user via a user interface of the budget tool;
tracking, in real-time by the financial institution computing system, actual expenditures by the user,
wherein the actual expenditures are conducted via a mobile wallet client hosted on the user device that communicates with a merchant point of sale (POS) system using Near Field Communication (NFC) signals;
facilitating, in real-time by the financial institution computing system, targeted advertising based on the individual budgets and the actual expenditures,
wherein the facilitating targeted advertising includes providing information relating to the individual budgets and the actual expenditures to an advertiser computing system operated by an advertiser;
receiving, by the financial institution computing system, an advertisement from the advertiser computing system selected based on the individual budgets and the actual expenditures;
displaying, by the financial institution computing system, the advertisement on the mobile application hosted on the user device associated with the user;
determining that the actual expenditures are ahead of the individual budgets;
stopping a credit card associated with the mobile application hosted on the user device in response to the determination that the actual expenditures are ahead of the individual budgets; and
providing a notification via the mobile application that the actual expenditures are ahead of the individual budgets.

14. (canceled)

15. (canceled)

16. A computing system associated with a financial institution, the computing system comprising:
a budgets database having information relating to budgets of users of the financial institution;
a network interface configured to communicate data to and from a payment network computing system, a user device associated with a user, and an advertiser computing system over a network;
memory; and
a processor structured to:
set up a budget for a user within a budget tool, the budget tool located on a mobile application hosted on the user device;
obtain individual budgets for categories of products and services for the user through the budget tool, wherein each individual budget includes an amount to spend for a corresponding category within a period of time, and wherein each individual budget is input by the user via a user interface of the budget tool;
track, in real-time, actual expenditures by the user,
wherein the actual expenditures are conducted via a mobile wallet client hosted on the user device that communicates with a merchant point of sale (POS) system using Near Field Communication (NFC) signals; and
facilitate, in real-time, targeted advertising based on the individual budgets and the actual expenditures,
wherein the processor is further structured to:
compare, a price of a particular product or service in a particular category offered by an advertisement with a remaining budget of the particular category, wherein the remaining budget is the balance of the budget for the particular category and the actual expenditures;
deliver the advertisement via the mobile application hosted on the user device in response to a comparison that the price is not higher than the remaining budget; and
cancel a credit card associated with the mobile application hosted on the user device in response to a comparison that the price is higher than the remaining budget.

17. A computing system associated with a financial institution, the computing system comprising:
a budgets database having information relating to budgets of users of the financial institution;
a network interface configured to communicate data to and from a payment network computing system, a user device associated with a user, and an advertiser computing system over a network;
memory; and
a processor structured to:
set up a budget for a user within a budget tool, the budget tool located on a mobile application hosted on the user device;
obtain individual budgets for categories of products and services for the user through the budget tool, wherein each individual budget includes an amount to spend for a corresponding category within a period of time, and wherein each individual budget is input by the user via a user interface of the budget tool;
track, in real-time, actual expenditures by the user,
wherein the actual expenditures are conducted via a mobile wallet client hosted on a mobile device of the user that communicates with a merchant point of sale (POS) system using Near Field Communication (NFC) signals; and
facilitate, in real-time, targeted advertising based on the individual budgets and the actual expenditures,
wherein the processor is further structured to:
determine whether the actual expenditure in a particular category is behind or ahead of the budget for the particular category;
provide an incentive that encourages spending in the particular category to the user in response to determining that the actual expenditure is behind the budget; and
stop a credit card associated with the mobile application in response to determining that the actual expenditure is ahead of the budget.

18. The system of claim 17, wherein the incentive includes at least one of delivering advertisements via the mobile application hosted on the user device about how to use a remaining budget for the particular category, and asking the user to shift budget from the particular category to another category for which the actual expenditure is ahead of the budget.

19. The system of claim 17, wherein the friction includes at least one of stopping delivering advertisements via the mobile application hosted on the user device on products and services in the particular category, asking the user to shift budget from another category for which the actual expenditure is behind the budget to the particular category, delivering advertisements via the mobile application hosted on the user device on less expensive alternatives in the particular category, and stopping credit cards when they are used for expenditures on products and services in the particular category.

20. A computing system associated with a financial institution, the computing system comprising:
a budgets database having information relating to budgets of users of the financial institution;
a network interface configured to communicate data to and from a payment network computing system, a user device associated with a user, and an advertiser computing system over a network;
memory; and
a processor structured to:
set up a budget for a user within a budget tool, the budget tool located on a mobile application hosted on the user device;
obtain individual budgets for categories of products and services for the user through the budget tool, wherein each individual budget includes an amount to spend for a corresponding category within a period of time, and wherein each individual budget is input by the user via a user interface of the budget tool;
track, in real-time, actual expenditures by the user,
wherein the actual expenditures are conducted via a mobile wallet client hosted on a mobile device of the user that communicates with a merchant point of sale (POS) system using Near Field Communication (NFC) signals; and
facilitate, in real-time, targeted advertising based on the individual budgets and the actual expenditures,
wherein the processor is further configured to:
compare a moving average of the actual expenditure in a particular category is above or below a budgeted average for the particular category;
provide an incentive that encourages spending in the particular category to the user in response to a comparison that the moving average is below the budgeted average; and
stop a credit card associated with the mobile wallet client in response to a comparison that the moving average is above the budgeted average.

21. (canceled)

22. (canceled)

23. A non-transitory computer-readable media having computer-executable instructions embodied therein, when executed by a processor of a financial institution computing system, cause the financial institution computing system to perform a process, the process including:
setting up a budget for a user within a budget tool, the budget tool located on a mobile application hosted on the user device;
obtaining individual budgets for categories of products and services for the user through the budget tool, wherein each individual budget includes an amount to spend for a corresponding category within a period of time, and wherein each individual budget is input by the user via a user interface of the budget tool;
tracking, in real-time, actual expenditures by the user,
wherein the actual expenditures are conducted via a mobile wallet client hosted on a mobile device of the user that communicates with a merchant point of sale (POS) system using Near Field Communication (NFC) signals; and
facilitating, in real-time, targeted advertising based on the individual budgets and the actual expenditures,
wherein the facilitating targeted advertising includes:
comparing, by the financial institution computing system, a price of a particular product or service in a particular category offered by an advertisement with a remaining budget of the particular category, wherein the remaining budget is the balance of the budget and the actual expenditures;
delivering the advertisement via the mobile application hosted on the user device in response to a comparison that the price is not higher than the remaining budget; and
stopping a credit card associated with the mobile application in response to a comparison that the price is higher than the remaining budget.

24. A non-transitory computer-readable media having computer-executable instructions embodied therein, when executed by a processor of a financial institution computing system, cause the financial institution computing system to perform a process, the process including:
setting up a budget for a user within a budget tool, the budget tool located on a mobile application hosted on the user device;
obtaining individual budgets for categories of products and services for the user through the budget tool, wherein each individual budget includes an amount to spend for a corresponding category within a period of time, and wherein each individual budget is input by the user via a user interface of the budget tool;
tracking, in real-time, actual expenditures by the user,
wherein the actual expenditures are conducted via a mobile wallet client hosted on a mobile device of the user that communicates with a merchant point of sale (POS) system using Near Field Communication (NFC) signals; and
facilitating, in real-time, targeted advertising based on the individual budgets and the actual expenditures,
wherein the facilitating targeted advertising includes:
determining whether the actual expenditure in a particular category is behind or ahead of the budget for the particular category;
providing an incentive that encourages spending in the particular category to the user in response to determining that the actual expenditure is behind the budget; and
stopping a credit card associated with the mobile application in response to determining that the actual expenditure is ahead of the budget.

25. The media of claim 24, wherein the providing an incentive includes at least one of delivering advertisements via the mobile application hosted on the user device about how to use a remaining budget for the particular category, and asking the user to shift budget from the particular category to another category for which the actual expenditure is ahead of the budget.

26. The media of claim 24, wherein the providing a friction includes at least one of stopping delivering advertisements via the mobile application hosted on the user device on products and services in the particular category, asking the user to shift budget from another category for which the actual expenditure is behind the budget to the particular category, delivering advertisements via the mobile application hosted on the user device on less expensive alternatives in the particular category, and stopping credit cards when they are used for expenditures on products and services in the particular category.

27. A non-transitory computer-readable media having computer-executable instructions embodied therein, when executed by a processor of a financial institution computing system, cause the financial institution computing system to perform a process, the process including:
setting up a budget for a user within a budget tool, the budget tool located on a mobile application hosted on the user device;
obtaining individual budgets for categories of products and services for the user through the budget tool, wherein each individual budget includes an amount to spend for a corresponding category within a period of time, and wherein each individual budget is input by the user via a user interface of the budget tool;
tracking, in real-time, actual expenditures by the user,
wherein the actual expenditures are conducted via a mobile wallet client hosted on a mobile device of the user that communicates with a merchant point of sale (POS) system using Near Field Communication (NFC) signals; and
facilitating, in real-time, targeted advertising based on the individual budgets and the actual expenditures,
wherein the facilitating targeted advertising includes:
comparing a moving average of the actual expenditure in a particular category is above or below a budgeted average for the particular category;
providing an incentive that encourages spending in the particular category to the user in response to a comparison that the moving average is below the budgeted average; and
stopping a credit card associated with the mobile application in response to a comparison that the moving average is above the budgeted average.

28. The method of claim 3, wherein the mobile wallet client is the same as the mobile application.

29. The method of claim 5, wherein the mobile wallet client is the same as the mobile application.

30. The method of claim 8, wherein the mobile wallet client is the same as the mobile application.

31. The method of claim 11, wherein the mobile wallet client is the same as the mobile application.

32. The method of claim 13, wherein the mobile wallet client is the same as the mobile application.

33. The system of claim 16, wherein the mobile wallet client is the same as the mobile application.

34. The system of claim 17, wherein the mobile wallet client is the same as the mobile application.

35. The system of claim 20, wherein the mobile wallet client is the same as the mobile application.

36. The process of claim 23, wherein the mobile wallet client is the same as the mobile application.

37. The process of claim 24, wherein the mobile wallet client is the same as the mobile application.

38. The process of claim 27, wherein the mobile wallet client is the same as the mobile application.
